(19) United States
(12) Patent Application Publication
(10) Pub. No.: US 2024/0403232 A1
(43) Pub. Date: Dec. 5, 2024

(54) INPUT CHANNEL ADJUSTMENT BASED ON DIRECTIONAL CONTEXT DATA

(71) Applicant: International Business Machines Corporation, Armonk, NY (US)

(72) Inventors: Logan Bailey, Atlanta, GA (US); Zachary A. Silverstein, Georgetown, TX (US); Su Liu, Austin, TX (US); Martin G. Keen, Cary, NC (US)

(21) Appl. No.: 18/327,913

(22) Filed: Jun. 2, 2023

(51) Int. Cl. G06F 13/10

(52) U.S. Cl. CPC G06F 13/102

(57) ABSTRACT

A computer-implemented method dynamically updates an input channel on a peripheral device. The method includes identifying two or more computing devices including a first computing device and a second computing device, where each of the two or more computing devices is capable of interacting with a first peripheral device. The method further includes connecting the first peripheral device to each of the two or more devices, where the first peripheral device is active with a first computing device of the two or more computing devices. The method also includes determining a status change of the first peripheral device. The method includes toggling, in response to the status change, a data exchange such that the first peripheral device is active with the second device and not active with the first device.

### BACKGROUND

The present disclosure relates to device inputs, and, more specifically, to dynamically altering output/input channels for peripheral devices.

Computer peripherals and/or input/output devices are used to send inputs to and receive outputs from computing devices. Multiple peripherals can be attached to a single device, and in some circumstances, a single peripheral can be compatible with multiple computing devices.

### SUMMARY

Disclosed is a computer-implemented method to dynamically update an input channel on a peripheral device. The method includes identifying two or more computing devices including a first computing device and a second computing device, wherein each of the two or more computing devices is capable of interacting with a first peripheral device. The method further includes connecting the first peripheral device to each of the two or more devices, wherein the first peripheral device is active with a first computing device of the two or more computing devices. The method also includes determining a status change of the first peripheral device. The method includes toggling, in response to the status change, a data exchange such that the first peripheral device is active with the second device and not active with the first device. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for dynamically toggling a peripheral device input, in accordance with some embodiments of the present disclosure.

FIG. 2 is a block diagram of a computing environment suitable for operation of a channel manager, in accordance with some embodiments of the present disclosure.

FIG. 3 is a flow chart of an example method to generate an update a peripheral input channel based on an update in conditions, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamically toggling a peripheral device input in block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

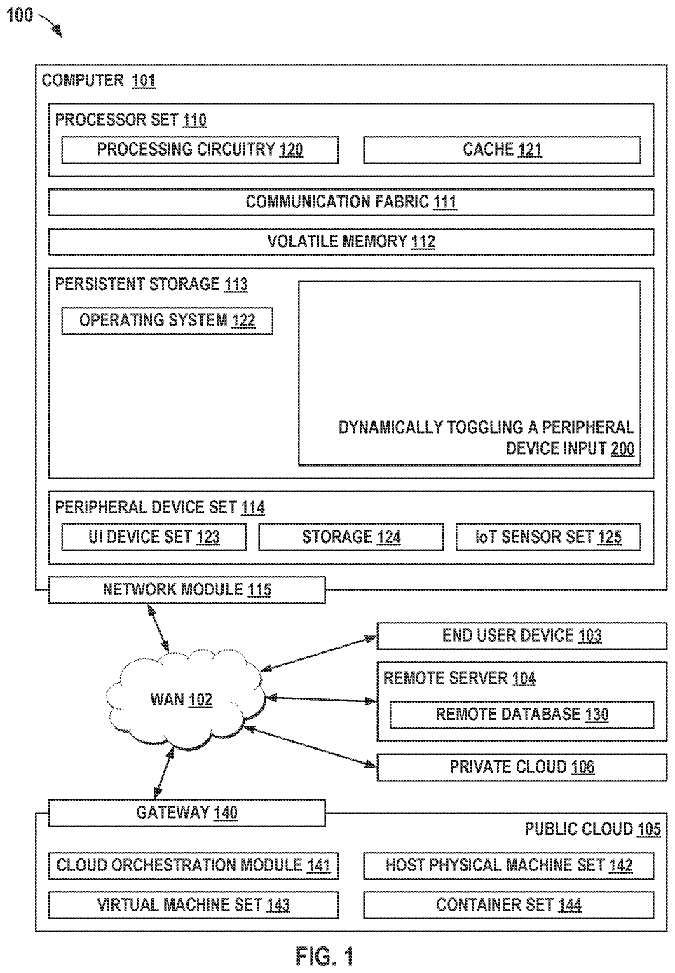

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure relates to device inputs, and, more specifically, to dynamically altering output/input channels for peripheral devices.

Computer peripherals, also known as input/output devices, are used to send inputs to and receive outputs from computing devices. Multiple peripherals can be attached to a single device, and in some circumstances, a single peripheral can be compatible with multiple computing devices.

In various locations, such as home and/or work environments, users can engage with multiple electronic computing devices. An example of this would be a user having multiple computers for performing different tasks. In another example, in a work from home environment, this could be as common as an individual with personal computer, a work computer, and/or one or more additional smart devices. Often users will utilize peripherals for interfacing with devices. In the examples mentioned above, a user may prefer to utilize the same peripherals, such as a particular keyboard and mouse when engaging with any device in their vicinity. However, altering the connection of the peripheral between multiple devices can be tedious and inefficient. For example, changing the input/output channel may include moving a Bluetooth receiver from one device to another, manually changing an input/output channel (e.g., a push button, setting change on a device, etc.), and the like. Alternatively, a single peripheral can be configured to provide an input to two devices simultaneously (e.g., two Bluetooth receivers for one Bluetooth mouse). However, if the two devices are both within range of the peripheral, the input may work for both devices simultaneously. Providing an input to or receiving an output from an unintended device can cause potential issues.

Embodiments of the present disclosure include a channel manager configured to dynamically alter an input/output channel for a peripheral device based on directional context of the peripheral. The altering of the channel makes the peripheral actively exchange data with a different computing device than prior to the update.

For the purposes of this application the channel manager can also be called an input manager and/or an output manager. In some embodiments, the channel manager can identify one or more computing devices. Each computing device is capable of exchanging data with one or more peripheral devices. The peripheral device can receive data from and/or send data to the computing device. In some embodiments, the peripheral is connected to each of the computing devices. For purposes of this disclosure, the term connected can be configured to exchange data, but not necessarily exchanging data at that time. For example, a peripheral can be connected to more than one computing device, but will be actively exchanging data with only one. Said differently, the peripheral can be connected to each multiple devices through a different output channel, and active only with one computing device, but when the peripheral is toggled to a different channel, no additional setup is needed to begin the active exchange of data. The peripheral has a unique channel for each computing device which prevents input into or output from an unintended device. At any time, the peripheral is actively exchanging data with one computing device, based on the currently selected channel.

In some embodiments, the channel manager identifies a status change. The status change can be a movement of the peripheral and/or computing device, a change in the environment, and the like. In some embodiments, the channel manager calculates/updates a toggle factor for the peripheral. The toggle factor represents a likelihood a user intents to use the peripheral with a particular device. In some embodiments, the channel manager determines if the status change and/or updated toggle factor result in a triggering event. A triggering event indicates the channel should be updated to make the peripheral active with a new computing device. The triggering event can be based on a ranking of the toggle scores and/or a predetermined threshold. In some embodiments, the channel manager dynamically alters/changes the input/output channel on the peripheral. This causes the peripheral to be active with a different computing device, thus, eliminating the need to manually update an input channel. This can save time and resources as a single peripheral can be used with multiple devices, and can be dynamically updated to be active to a particular device based on the current location, uses, and other environmental factors. In some embodiments, the channel manager continuously monitors for additional status changes and updates the toggle factors as needed.

The aforementioned advantages are example advantages, and embodiments exist that can contain all, some, or none of the aforementioned advantages while remaining within the spirit and scope of the present disclosure.

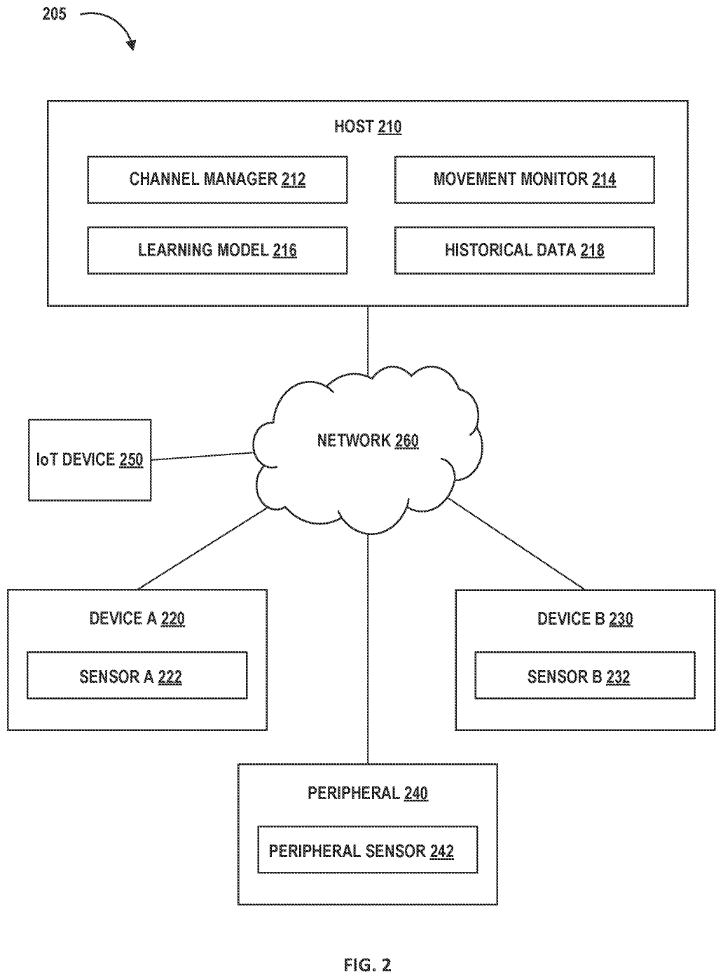

Referring now to various embodiments of the disclosure in more detail, FIG. 2 is a representation of a computing environment 205, that is capable of running a channel manager. Many modifications to the depicted environment may be made by those skilled in the art without departing from the scope of the disclosure.

Computing environment 205 includes host 210, device A 220, device B 230, peripheral 240, IoT device 250, and network 260. Network 260 can be, for example, a telecommunications network, a local area network (LAN), a wide area network (WAN), such as the Internet, or a combination of the three, and can include wired, wireless, or fiber optic connections. Network 260 may include one or more wired and/or wireless networks that are capable of receiving and transmitting data, voice, and/or video signals, including multimedia signals that include voice, data, and video information. In general, network 260 may be any combination of connections and protocols that will support communications between and among host 210, device A 220, device B 230, peripheral 240, IoT device 250, and other computing devices (not shown) within computing environment 205. In some embodiments, each of host 210, device A 220, device B 230, peripheral 240, IoT device 250, and other devices not shown may include one or more a computer system, such as computer 101 of FIG. 1. In some embodiments, network 260 can be consistent with WAN 102 of FIG. 1.

In some embodiments, network 260 can represent two or more different networks. A second network can be a connection between peripheral 240 and the other components within computing environment 205. The second network can be any network that allows peripheral 240 to receive and/or send data to device A 220 and/or device B 230.

Host 210 can be a standalone computing device, a management server, a web server, a mobile computing device, or any other electronic device or computing system capable of receiving, sending, and processing data. In other embodiments, host 210 can represent a server computing system utilizing multiple computers as a server system, such as in a cloud computing environment (e.g., cloud environment 105 or 106). In some embodiments, host 210 includes channel manager 212, movement monitor 214, learning model 216, and historical data 218. In some embodiments, host 210 and/or any or all of the subcomponents of host 210 can be contained/included in one or more of device A 220, device B 230, peripheral 240, and IoT device 250.

Channel manager 212 can be any combination of hardware and/or software configured to dynamically adjust an input/output channel between a peripheral device (e.g., peripheral 240) and at least one eligible computing device. Said differently, embodiments of the current disclosure can identify, based on movement and other IoT data from a peripheral and two or more devices, when actions indicate an intent for a user to change active data exchange from a current device to a different device, and dynamically adjust channels in peripheral or computing devices to communicate with the different device. In some embodiments, channel manager 212 includes one or more of movement monitor 214, learning model 216, and historical data 218, however, they are shown as separate components for discussion purposes.

In some embodiments, channel manager 212 identifies triggers or triggering events. A trigger can be a determination that a channel should be toggled or adjusted to become active with a different computing device. In some embodiments, the trigger can be based on information determined from one or more of historical data 218, learning model 216, and movement monitor 214. The information can be gathered from sensors within the various components of computing environment 205, historical data, and other environmental and relevant inputs. In some embodiments, the trigger can be based on a toggling factor (or trigger factor) being above threshold. The toggling factor represents a likelihood peripheral 240 is intended to be used as an input/output for a particular device. The factor can be a ranking of each of the potential devices. The trigger would be whenever a new device obtains the top rank. The trigger can be a threshold. For example, anytime it is determined that the likelihood of using a peripheral with a particular device rises above 50% or 0.5, then that is a triggering event.

Movement monitor 214 can be any combination of hardware and/or software configured to determine movement direction, and/or relative positions of peripherals and computing devices within computing environment 205. In some embodiments, movement monitor 214 received data from one or more of device A 220, device B 230, peripheral 240, and IoT device 250. The data can be the data gathered by the one or more sensors associated with each device. Movement monitor 214 can analyze all the previously received and incoming data. In some embodiments, movement monitor 214 determines movement of peripherals toward and/or away from each device.

In some embodiments, the data can include direction data, special data, and context data. Directional data can be data that represents the movement of a particular component. This data can be for each device individually and/or relative to one or more different components. Movement data can include rotational data, angular data, directional data, and the like. In some embodiments, spatial data includes distances, flight time of signals, relative signal strengths, GPS data, and the like. In some embodiments, the spatial data can be received from the various sensors and/or derived from direction data. In some embodiments, spatial data is used to map the relative locations of components. Context data includes the device category, environmental data (e.g., number of persons in vicinity), time data (e.g., time of day, day of week, etc.), user preferences, historical data, and the like.

In some embodiments, movement monitor 214 determines/calculates the toggling factor (or use factor). The toggling factor can be determined with learning model 216. In some embodiments, each time new data is received, movement monitor 214 can update the relevant toggling factors. In some embodiments, movement monitor 214 can include learning model 216. Movement monitor 214 can continuously monitor for new directional, and spatial data, and for environment changes. The new inputs can be continually monitored and cause the toggling score to be updated. For example, movement of a mouse from room A to room B can be enough to be a trigger. In some cases, the time of day may be a factor. If it is in the middle of a workday, the movement may not result in a triggering event, but if that same movement occurs after work hours or on a weekend, it can be determined to be a triggering event.

Learning model 216 can be any combination of hardware and/or software configured to identify an intended input made on a peripheral to a device. In some embodiments, learning model can use past usage data from historical data 218 as training data. In some embodiments learning model 216 can receive current data in real time. The inputs can include locations of the devices/components within computing environment 205. Learning model 216, based on the current inputs, determines a likelihood/probability that the user is intending to use a particular device. In some embodiments, learning model 216 can calculate a probability of intent to use for one or more devices. The output and/or probability can be sent to channel manager 212.

In some embodiments, learning model 216 may execute machine learning on data from the environment using one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR). In some embodiments, display manager 230 may execute machine learning using one or more of the following example techniques: principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), region-based convolution neural networks (RCNN), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

Historical data 218 can be information related to a user's preferences and trends regarding uses of peripheral 240 with one or more devices. Historical data can include manual toggles, and updatable preferences. In some embodiments, historical data 218 includes times when each device is actively exchanging data with each computing device. In some embodiments, historical data 218 can track and record movements, patterns, and other similar uses. Historical data can be used as training data for learning model 216. The training data can be based on pre-recorded movements, manual toggles, environmental factors, and the other similar inputs, which are correlated to manual toggles, locations, inputs, and other known uses. In some embodiments, historical data 218 can provide inputs to determine the toggling factor.

Device A 220 can be any computing device. In some embodiments, device A 220 can be consistent with computer 101 of FIG. 1. Device A 220 be configured to receive an input from and/or send an output to peripheral 240 (and/or other connected devices). In some embodiments, device A 220 can have a use designation. For example, use designation can include work, home, entertainment, and the like.

In some embodiments, device A 220 can receive input from and/or send an output to peripheral 240. The input and output can be received and/or sent through a specific channel. Each different peripheral can have the same and/or different channels. For example, a keyboard and mouse set may have a common and/or different input channel. In another example, an output channel for a headset to play sound and an output channel to activate a smart IoT device can be different channels. In some embodiments, each peripheral can be toggled on and off. The toggle instruction can be based on an input from the user and/or from any components (e.g., channel manager 212) within computing environment 205. In some embodiments, device A 220 can include host 210 and all or any subset of the components within host 210.

In some embodiments, device A 220 includes sensor A 222. Sensor A 222 can be any combination of hardware and/or software configured to gather location and/or movement data. In some embodiments, sensor A 222 can include two or more individual sensors. In some embodiments, sensor A 222 can be configured to collect location and/or directional data. Location data can be data that identifies the location of device A 220. The location can be an absolute location and/or location relative to the other devices within computing environment 205. In some embodiments, sensor A 222 includes a global positioning system (GPS) sensor. The GPS can identify a location based on signals from a network of satellites. The location data can be input and sent to channel manager 212 and/or movement monitor 214.

The directional data can capture movement and directional data. Sensor A 222 can include one or more accelerometers, acceleration sensor, gyroscope, and magnetometer to capture directional data. The data gathered by the sensor can be sent to channel manager 212 and/or movement monitor 214. Sensor A 222 can continuously monitor for movement. The various movement components can distinguish between moving a mouse on a desk and carrying the mouse to a different room. For example, if an accelerometer is detecting motion in only two directions with no rotation as it moves around a two-dimensional surface, that can be distinguished from lifting the mouse in a third direction and/or rotating the mouse around a third directional axis. The lifting and rotation can indicate an intention to use the mouse for a different device.

Device B 230 can be any computing device. In some embodiments, device B 230 can be consistent with computer 101 of FIG. 1. In some embodiments, device B 230 can be consistent with device A 230.

Sensor B 232 can be any combination of hardware and/or software configured to gather location and/or movement data. In some embodiments, sensor B 232 can be consistent with sensor A 222.

Device B 230 and device A 220 can be movable within an environment. In various embodiments, they can be the same and/or a different category and in the same or a different location within an environment.

Peripheral 240 can be any combination of hardware and/or software configured to send and/or receive data to one or more computing devices. In some embodiments, peripheral 240 can be communicatively connected to one or more devices (e.g., device A 220 and device B 230). The connection allows for the sending and/or receiving of data. Peripheral 240 can receive data from (an output of) a device, and/or send data to (an input to) the device. The connections to a single device can be single and/or multi-channel connections. However, different channels may be used for the same data signal for different devices. The different channels allow for the toggle/changing of channels between multiple devices when peripheral 240 is within range of multiple devices.

In some embodiments, computing environment 205 can include two or more different peripherals 240. Each of peripheral 240 can have a unique function. For example, in one embodiment, there can be a mouse, a keyboard, and a headset. Each of these can be configured to connect to one of device A 220 and device B 230. However, only they may only be connected to one of the devices at the same time. Channel manager 212 can toggle which device is active with each peripheral through the various inputs. The toggle can occur within the peripheral and/or within the devices. In some embodiments, two or more of the peripherals can be treated as a single device. Continuing the above example, the mouse and keyboard will be connected to the same device. When the mouse is toggled, the keyboard is also toggled. This can occur on the same or different channels. In some embodiments, each peripheral can be toggled independently. Using the above example, the mouse can be toggled between devices while the keyboard stays connected to the same device.

Peripheral sensor 242 can be any combination of hardware and/or software configured to gather location and/or movement data. In some embodiments, peripheral sensor 242 can be consistent with sensor A 222.

IoT device 250 can be any device configured to capture and send data to channel manager 212. In some embodiments, computing environment 205 contains two or more separate IoT device 250's. The two or more devices can be distributed around computing environment 205 where multiple devices are present (e.g., a home). For example, each room of the area can have one IoT device. Another example, each area of the home can be covered by one or more IoT devices.

In some embodiments, IoT device 250 can include any number of sensors consistent with sensor A 222. Additionally, IoT device 250 can include sensors that can sense movement (e.g., cameras and motion sensors). IoT device 250 can detect when a user leaves one room and enters another. In some embodiments, IoT device 250 can determine if multiple persons are in the vicinity of a device. The user movement and number of person information can be sent to channel manager 212. This information can be an input used to determine the intent for a user to use peripheral 240 with a particular device. For example, if a user enters a room with several others while at home, that can indicate a lower likelihood the user will interact with a work computer, but also can indicate a higher likelihood of using a personal computer.

In some embodiments, IoT device 250 can gather data configured to provide data input about relevancy of noise. In various embodiments, there can be any number of devices consistent with IoT device 230. Each device can include one or more sensors. A sensor can be any combination of hardware and/or software configured to gather data surrounding IoT device 230. IoT device 230 can have any number of sensors of any type. The type of sensors can include microphones, cameras, motion sensors, and the like. In various embodiments, IoT devices 230 can capture noise data used as an input to identify the source of data. The cameras can be used to identify locations and/or potential sources of noise/conversations.

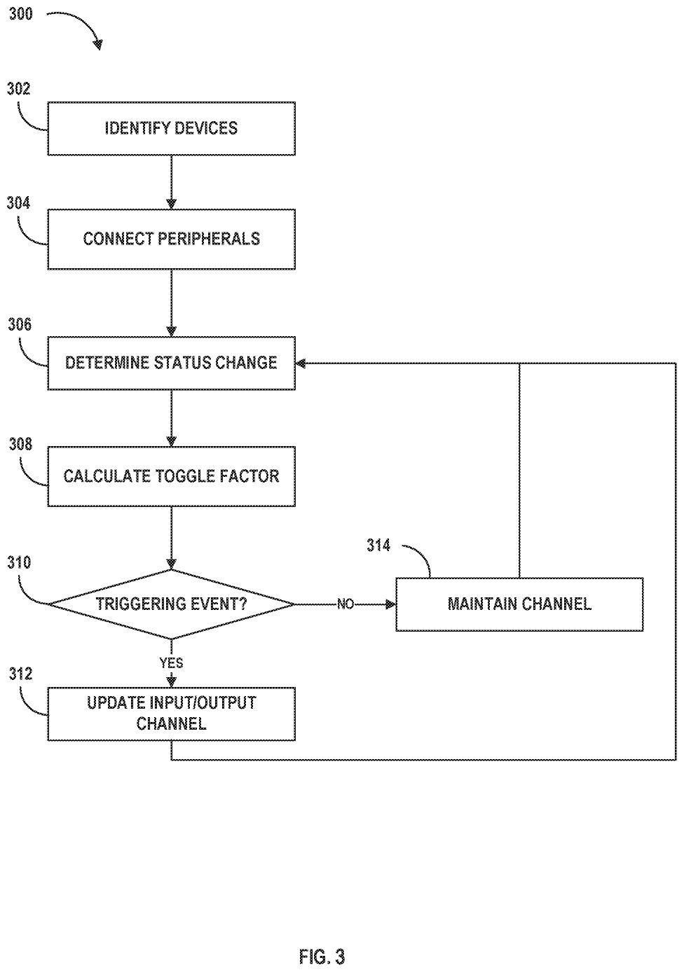

FIG. 3 depicts a flowchart of an example method, process 300, for operating a channel manager in a computing environment (e.g., computing environment 100 and/or computing environment 205). One or more of the advantages and improvements described above for training operating a channel manager may be realized by process 300, consistent with various embodiments of the present disclosure.

Process 300 can be implemented by one or more processors, host 210, channel manager 212, movement monitor 214, learning model 216, historical data 218, device A 220, sensor A 222, device B 230, sensor B 232, peripheral 240, peripheral sensor 242, IoT device 250, and/or a different combination of hardware and/or software. In various embodiments, the various operations of process 300 are performed by one or more of host 210, channel manager 212, movement monitor 214, learning model 216, historical data 218, device A 220, sensor A 222, device B 230, sensor B 232, peripheral 240, peripheral sensor 242, IoT device 250, For illustrative purposes, the process 300 will be described as being performed by channel manager 212.

At operation 302, channel manager 212 identifies one or more computing devices (e.g., device A 220 and device B 230). The computing devices can be any device capable of connection to exchanging data (e.g., sending and/or receiving) with a peripheral device (e.g., peripheral 240). In some embodiments, each of the two or more computing devices have device category. The category defines a typical mode of use. Some categories can include personal, work, all, entertainment, family, and the like. Each of the two or more devices can be located in a common location, such as a home, an office, or the like.

At operation 304, channel manager 212 connects peripheral devices to the one or more computing devices. In some embodiments, the peripheral devices are peripheral 240. Peripheral 240 is connected to two or more of the devices identified in operation 302. Connected can mean compatible with and any necessary drivers are installed and ready to use. However, at any given time, the peripheral device is only active with one of the identified devices. Active means actively sending and/or receiving data from the device. For example, a mouse can have two different Bluetooth receivers, one installed in each of two different laptops. The mouse will contain at least one channel to communicate with each laptop individually. At any given time, the mouse will be configured (toggled) to provide an input to one of the laptops. The mouse can be toggled, mechanically and/or digitally, to change a channel within the mouse such that the input is to the second laptop. Alternatively, the mouse can communicate with both laptops on the same channel. However, channel manager 212 will maintain only one channel active for the group of laptops. Rather than the channel changing on the peripheral, the input/output can be toggled on and off to make specific laptops active with the peripheral.

In some embodiments, the connection can be any connection that allows for the transfer of data. The connection can be a short-wave wireless communication method such as Bluetooth®. In some embodiments, the connection between the peripheral and the identified computing devices is separate from network 260. In some embodiments, the connection can be a local network, or personal network in conjunction with or separate from network 260. The local network can utilize Wi-Fi® and other similar technologies.

At operation 306, channel manager 212 identifies a status change. In some embodiments, a status change can include receiving data from one or more sensors within computing environment 205 (e.g., IoT device, peripheral sensor 242, etc.). The data can be movement data, special data, and the like. In some embodiments, the status change is an environmental change. For example, the end of a workday can be a status change. In another example, a non-user person enters/leaves an area associated with the peripheral/device.

In some embodiments, a status change can be only based on movement of the peripheral or one of the one or more computing devices. The other factors will still be used, just not as a status change to proceed to operation 308. In some embodiments, the status change is for a particular device. For example, if there are two different peripherals, each peripheral can be treated individually. The movement of a first peripheral will cause the next operations for that peripheral, but not for the second peripheral. If both peripherals are connected to a computing device and the computing device moves, then that may trigger the next operations for all peripherals connected to the moved device. In some embodiments, a status change of one peripheral can cause the next operation for all peripherals connected to any of the one or more computing devices identified in operation 302.

At operation 308, channel manager 212 calculates a toggle factor. In some embodiments, the toggle factor can represent a likelihood a user intends to use a peripheral with a particular computing device. In some embodiments, the toggle factor can be based on one or more of sensor data, location data, movement data, special data, historical data, device category, and the like. Channel Manager 212 can analyze all of the inputs to determine if movement and/or environmental data indicate an input channel change is warranted.

In some embodiments, the toggle factor is a ranking of likelihood of uses. In some embodiments, the toggle factor can be a percentage (or confidence score). In some embodiments, the percentage/likelihood and ranking can be combined. For example, each device connected to a peripheral can have a toggle factor, and then the devices are ranked according to the toggle factor. The toggle factor can be representative of the relationship/likelihood of use between one peripheral and one device. Thus, there are enough toggle factors for each peripheral to each of the one or more computing devices. They can be an absolute score. In some embodiments, the toggle factor can be relative to each of the computing devise. For example, the sum of toggle factors for a particular peripheral, when added together, equals one.

In some embodiments, the toggle factor is calculated by one or more of movement monitor 214 and learning model 216. All of the data points that are used as training data for learning model 216 can be an input into the calculation. In some embodiments, the toggle factor is continuously updated. For example, as time can be an input, time is continuously changing, as such, the toggle factor can be updated very frequently. In some embodiments, the toggle factor is updated in response to a significant change. A significant change can be an abnormal movement (e.g., a mouse changing rooms/rotating). A significant change can be based on environmental factors such as predetermined times, etc. In some embodiments, operation 308 is performed in response to a movement of the peripheral and/or one of the one or more computing devices. In multiple peripheral embodiments, each peripheral can have a separate toggle factor. The toggle factor can vary based on a type of peripheral. For example, all other inputs being equal, a mouse can have a different toggle factor than a headset.

At operation 310, channel manager 212 determines if a triggering event has occurred. A triggering event can be any event that indicates a channel should be changed such that the peripheral is exchanging data with a different device. In some embodiments, the triggering event can be based on the toggle factor. In some embodiments, determining a triggering event is based on a change in the toggle factor rankings. Each time a new device becomes the top ranked device, that can be a triggering factor. In some embodiments, determining a triggering event is based on a threshold. For example, if a particular movement causes a toggle factor for a mouse and a device to increase above the predetermined threshold, then it is determined to be a triggering factor. However, falling below the same threshold can be a triggering factor, or may not be a triggering factor, depending on the embodiment. The triggering events can be unique to each peripheral. For example, the threshold for a mouse can be different than the threshold for a keyboard.

If it is determined a triggering event has occurred (310: YES), then channel manager 212 proceeds to operation 312. If it is determined that a triggering event has not occurred (310: NO), then channel manager 212 proceeds to operation 314.

At operation 312, channel manager 212 updates the channel. The channel can be the input/output channel. In some embodiments, the channel is changed on the peripheral. The toggle can be at the hardware level and/or the software level. The toggle can be in response to a signal from channel manager 212 instructing the device to update the channel. The new channel is based on the toggle factor. Whichever device is associated with the triggering event (e.g., topmost ranked toggle factor, exceeded threshold, etc.) becomes the active device. After updating the channel, channel manager 212 return to operation 306 to monitor and determine the next status change.

In some embodiments, the update occurs on the identified computing devices. The input/output can be toggled on and off based on the toggle factor. This will have the same effect as changing a channel on the peripheral. If the peripheral lacks multiple channels, toggling on the computing devices allows for the same result of dynamically altering the active peripheral connection-based context movement of the devices.

At operation 314 channel manager 212 maintains the current channel. Upon completion of operation 314, channel manager 212 returns to operation 306 to monitor for and determine the next status change.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying two or more computing devices including a first computing device and a second computing device, wherein each of the two or more computing devices is capable of interacting with a peripheral device;
connecting the peripheral device to each of the two or more computing devices, wherein the peripheral device is active with the first computing device of the two or more computing devices;
determining a status change of the peripheral device;
toggling, in response to the status change, a data exchange such that the peripheral device is active with the second computing device and not active with the first computing device.

2. The computer-implemented method of claim 1, further comprising:
calculating, in response to the status change, a toggle factor for each of the two or computing devices, wherein the toggle factor indicates a likelihood the peripheral device is intended to be used with a particular device.

3. The computer-implemented method of claim 2, wherein the toggling is in response to the toggle factor for the second computing device exceeding a predetermined threshold.

4. The computer-implemented method of claim 2, wherein the toggle factor ranks each of the two or more computing devices.

5. The computer-implemented method of claim 4, wherein the toggling is in response to the toggle factor for the second computing device being a higher rank than a toggle factor for the first device.

6. The computer-implemented method of claim 5, wherein a changing of a topmost ranked computing device is a triggering event for the toggling.

7. The computer-implemented method of claim 1, further comprising:
monitoring the peripheral device and each of the computing devices for a change in movement data, special data, and environmental data, wherein the status change is based on a change in the monitored data.

8. The computer-implemented method of claim 1, wherein each computing device and the peripheral device include at least one sensor, wherein the at least one sensor detects movement.

9. The computer-implemented method of claim 1, wherein the toggling includes changing an input channel on the peripheral device.

10. The computer-implemented method of claim 1, wherein the toggling turning off a first data input on the first device from the peripheral device and turning on a first data input on the second device from the peripheral device.

11. A system comprising:
a processor;
two or more computing devices;
a peripheral configured to provide an input to the two or more computing devices, wherein the peripheral is actively exchanging data with one computing device of the two or more devices; and
a computer-readable storage medium communicatively coupled to the processor and storing program instructions which, when executed by the processor, are configured to cause the processor to:
determine a status change of the peripheral; and
toggle, in response to the status change, the peripheral to actively exchange data with a second computing device and stop exchanging data with the one computing device.

12. The system of claim 11, wherein the toggling includes changing an input channel on the peripheral.

13. The system of claim 11, wherein the toggling includes turning off a first data input on the one computing device and turning on a first data input on the second computing device.

14. The system of claim 11, further comprising:
a channel manager configured to calculate a toggle score, wherein the toggle score indicates a likelihood the peripheral is intended to be used with a particular device; and
the program instructions are further configured to cause the processor to:
calculate, in response to the status change, a toggle factor for each computing device.

15. The system of claim 14, further comprising:
a movement monitor configured to monitor the peripheral and each of the two or more computing device for a change in movement data, special data, and environmental data, wherein the status change is based on a change in the monitored data.

16. A computer program product, the computer program product comprising a computer readable storage medium having program instructions embodied therewith, the program instructions executable by a processing unit to cause the processing unit to:
identify two or more computing devices including a first computing device and a second computing device, wherein each of the two or more computing devices is capable of interacting with a first peripheral;
connect the first peripheral to each of the two or more devices, wherein the first peripheral device is active with a first computing device of the two or more computing devices;
determine a status change of the first peripheral; and
toggle, in response to the status change, a data exchange such that the first peripheral is active with the second computing device and not active with the first computing device.

17. The computer program product of claim 16, wherein the toggling includes changing an input channel on the first peripheral.

18. The computer program product of claim 16, wherein the toggling turning off a first data input on the first device from the first peripheral and turning on a first data input on the second device from the first peripheral.

19. The computer program product of claim 16, wherein the program instructions are further configured to cause the processing unit to:
calculate, in response to the status change, a toggle factor for each computing device, wherein the toggle factor indicates a likelihood the peripheral is intended to be used with a particular device.

20. The computer program product of claim 19, wherein the toggling is in response to the toggle factor for the second computing device exceeding a predetermined threshold.
